(19) United States
(12) Patent Application Publication
(10) Pub. No.: US 2010/0116107 A1
(43) Pub. Date: May 13, 2010

(54) APPARATUS AND METHOD FOR EFFICIENT SMEAR-LESS SLICING OF MEAT, POULTRY AND SIMILAR FOOD PRODUCTS

(75) Inventors: Wayne SPILLNER, Warrenton, VA (US); Lee Clarkson, Amissville, VA (US); Bill Clowater, Gordonsville, VA (US); Thomas G. Tracy, Woodford, VA (US); Sal Sparacino, Fairfax, VA (US)

Correspondence Address: MCGUIREWOODS, LLP, 1750 TYSONS BLVD, SUITE 1800, MCLEAN, VA, 22102, US

(73) Assignee: Ross Industries, Inc., Midland, VA (US)

(21) Appl. No.: 12/615,113

(22) Filed: Nov. 9, 2009

Related U.S. Application Data
(60) Provisional application No. 61/193,246, filed on Nov. 10, 2008.

(51) Int. Cl. B26D 1/00; A47J 43/04; B26D 7/08; B26D 7/06

(52) U.S. Cl. 83/13; 99/537; 83/169; 83/437.1

(57) ABSTRACT

A slicer system and method is disclosed that cuts meat products from a primal. The system comprises an isolated chute that delivers the primal to a cutting area along a first direction, a shuttle that moves a portion of the primal in a horizontal plane that is substantially perpendicular to the first direction, a conveyor that supports and carries a meat product cut from the primal in the cutting area, and a sprayer that applies a fluid to a cutting blade in the cutting area.

### CROSS REFERENCE TO PRIOR APPLICATIONS

This application claims priority and the benefit thereof from U.S. Provisional Patent Application Ser. No. 61/193,246, filed on Nov. 10, 2008, which is herein incorporated by reference in its entirety.

### BACKGROUND

1. Field

The disclosure relates to an apparatus, a system and a method for cutting meat products, including, but not limited to, for example, pork, red meat, poultry and the like. In particular, the disclosure relates to an apparatus, a system and a method for smear-less cutting of meat products to provide an optimal quality meat product.

2. Related Art

Dressing and cutting of meat products has traditionally been done manually. With ever-increasing demand for affordable cuts of meat products, the dressing and cutting processes are progressively becoming fully automated. High speed production slicers have become commonplace in meat processing plants. However, it has been found that high speed production slicers are susceptible to fat smear (especially for pork chops) and, with bone-in slicing, bone dust, bone fragments, splinters, shards and chips, resulting from a blade slicing through the meat and bone.

The following are examples of high speed food slicers: U.S. Pat. No. 5,136,908, issued on Aug. 11, 1992, to Callandrello, discloses a food slicer apparatus and knife therefor; U.S. Pat. No. 5,197,681, issued on Mar. 30, 1993, to Liebermann, discloses an apparatus for safe high speed slicing/shaving of a food product; U.S. Pat. No. 5,271,304, issued on Dec. 21, 1993, to Wygal et al., discloses an automatic food slicing machine; U.S. Pat. No. 5,989,116, issued on Nov. 23, 1999, to Johnson et al., discloses a high-speed bone-in loin slicer; and U.S. Pat. No. 6,882,434, issued on Apr. 19, 2005, to Sandberg et al., discloses an automated product profiling apparatus and product slicing system using same.

### SUMMARY OF THE DISCLOSURE

According to an aspect of the invention, a slicer system is provided for cutting meat products from a primal. The slicer system comprises: an isolated chute that delivers the primal to a cutting area along a first direction; a shuttle that moves a portion of the primal in a horizontal plane that is substantially perpendicular to the first direction; a conveyor that supports and carries a meat product cut from the primal in the cutting area; and a sprayer that applies a fluid to a cutting blade in the cutting area. The slicer system may further comprise: a chute drive that controls a position of the primal in the chute along the first direction; a shuttle drive that controls the position of the primal in the horizontal plane; a conveyor drive that moves the conveyor; and a sprayer drive that regulates the supply of fluid to the cutting blade, wherein the fluid comprises at least one of a lubricating fluid, a processing acid, water, or a preservative. The fluid may be intermittently applied to the cutting blade. The cutting blade may comprise a synergistic infused matrix coating. The synergistic infused matrix coating may comprise at least one of: an Endura® 203x3 coating; an Armoloy XADC® coating; an Endura® 202P coating; a PenTuf®/En infused coating; an EN/PenTuf® Infused coating; a Nedox® coating; a Plasmadize® coating; a Goldenedge® coating; a BryCoat™ Titanium Carbo-Nitride coating; an Armoloy® TDC Thin Dense Chromium Finish coating; a Wearalon® coating; or a nickel alloy matrix with the controlled infusion of sub-micron sized particles of high temperature, low friction polymers. The synergistic infused matrix coating may comprise: a coating thickness of about 0.0001 inches to about 0.001 inches; a maximum operating temperature of about 500° F. continuous; a coefficient of thermal expansion of about 14 μm/m/° C.; a modulus of elasticity of about 2.0×10⁵ N/mm²; a hardness (Rockwell C) of about 62 to about 68; a taber abrasion resistance of about 0.03 g; a salt spray resistance of about 1500+h; a friction coefficient, dynamic/static of at least 0.02 to about 0.08; or a surface energy of about 14 to about 18 dyne-cm. The synergistic infused matrix coating may be applied to the cutting blade by microcracking electroless nickel at high temperatures and infusing polytetrafluroethylene (PTFE) into the resultant cracks. The cutting blade may comprise: a sharpened edge; a serrated edge; a fine saw-tooth edge; a smooth tapered radial ribbing edge; or a slight beveling edge, including the Grantons.

The slicer system may further comprise: a rotatable crescent shaped (or similarly configured) thickness table that regulates the thickness of the meat product, wherein the cutting blade and thickness table comprises a smooth micro-finish with a non-stick release surface; and/or an eccentric cutter drive that drives the cutting blade.

The slicer system may further comprise: a linear transducer that is configured to provide an adjustable downward pressure on a product follower, wherein the downward pressure is maintained at a constant value, regardless of the weight of the primal; and/or a removable handle that is configured to be placed in the chute, wherein the removable handle facilitates easy and safe positioning of a product follower.

According to a further aspect of the invention, a slicer is provided for cutting meat products from a primal. The slicer comprises: a chute that delivers the primal to a cutting area; a blade that slices a meat product from the primal in the cutting area; and a blade driver that is configured to drive the blade at varying speeds to regulate a slice rate, wherein the slice rate is based on a temperature at which the primal is sliced, the quantity of a fat layer, or whether the primal comprises a bone. The slicer may further comprise: a conveyor that carries the meat product away from the cutting area; and/or a shuttle that shuttles the meat product in the cutting area; and/or a manifold that supplies a pressurized fluid to a nozzle, wherein the nozzle applies a mist or a stream to the cutting blade in any one of three modes, including a continuous misting mode, an intermittent misting mode, or an isolated SIM flush cleaning mode.

According to a further aspect of the invention, a method is provided for slicing a meat product from a primal. The method comprises: displaying a main menu screen comprising a plurality of modes; receiving a selected mode from the plurality of modes; receiving a plurality of control parameters; and adjusting at least one of a cutting blade speed, a cutter blade speed, a conveyor speed, a batch dwell speed and a cut pressure speed based on the received plurality of control parameters. The plurality of modes may comprise: a machine setup mode; a SIMS configure mode; an intermittent misting configure mode; a supervisory administration screen mode; an options mode; a manual movement mode; an inputs screen mode; an outputs screen mode; a continuous thickness mode; a continuous run mode; a variable thickness mode; a library screen mode; a language mode; or a security mode.

The plurality of control parameters may comprise: a meat product thickness; a batch number; a number of slices; thickness averaging to improve yield and eliminate a discarded end product; a continuous misting control signal; an intermittent misting control signal; a SIMS control signal; or a chute management control signal.

The method may further comprise: cooling the primal to a deep crust chill or full temper prior to cutting; and/or applying a fluid to a cutting blade on a basis of the plurality of control parameters.

The method may further comprise: closing a shutter and isolating a primal in a chute; moving a thickness table to a position for cleaning; and applying a jet of fluid to the thickness table and a cutting blade to flush away any deposited fat smear. The chute may be isolated from a cutting area that includes the cutting blade and the thickness table. The fluid may comprise at least one of water, a processing acid, a flavor enhanced solution, a preservative, an antimicrobial solution, and an oil. The processing acid may comprise citric acid and the flavor enhanced solution may comprise salt.

The method may further comprise: sending effluent water containing the flushed away fat smear to a scupper; screening fat from the effluent water; and discarding the screened effluent water.

Additional features, advantages, and embodiments of the disclosure may be set forth or apparent from consideration of the following detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a slicer, according to principles of the disclosure;

FIG. 2 shows an example of a schematic of a slicer system, which may be used in the slicer of FIG. 1, according to principles of the disclosure;

FIG. 3 shows an example of a vertical primal chute that may be used in the slicer of FIG. 1, according to principles of the disclosure;

FIG. 4 shows an example of a slicing platform system that may be used in the slicer of FIG. 1, according to principles of the disclosure;

FIG. 5A shows an embodiment of a pair of chutes and chute drive sections, according to principles of the disclosure;

FIG. 5B shows an embodiment of a pair of shuttles and associated shuttle drive sections, according to principles of the disclosure;

FIG. 7 shows an example of a variable thickness mode display screen, according to principles of the disclosure;

FIG. 8 shows an example of a program editing display screen for the variable thickness mode, according to principles of the disclosure;

FIG. 9 shows an example of an options mode display screen, according to principles of the disclosure;

FIG. 10 shows an example of a manual movements mode display screen, according to principles of the disclosure;

FIG. 11 shows an example of a machine configure mode display screen, according to principles of the disclosure;

FIG. 12 shows an example of an intermittent misting configuration mode display screen, according to principles of the disclosure;

FIG. 13 shows an example of a continuous run mode display screen, according to principles of the disclosure;

FIG. 14 shows an example of a SIM configuration mode display screen;

FIG. 15 shows an example of a SIM process, according to principles of the disclosure;

FIG. 16 shows an example of the SIM process for a pair of left and right chutes, according to principles of the disclosure;

FIG. 17 shows an example of a water flush assembly that may be used in the slicer of FIG. 1, according to principles of the disclosure;

FIG. 18 shows an example of a process for slicing a meat product from a primal, according to principles of the disclosure;

FIG. 19 shows an example of a cutting blade and a thickness table that may be used in the slicer of FIG. 1, according to principles of the disclosure;

FIG. 20 shows an example of a pair of left and right shutters that may be used in the slicer of FIG. 1, according to principles of the disclosure; and

FIGS. 21A, 21B show an example of a detachable handle in an attached and detached configuration, respectively, that may be used in the vertical chutes of the slicer of FIG. 1, according to principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings, and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

Many factors impact the quality of cut meat products, including, for example, but not limited to: the speed of the cutting blade used to slice (or cut) the meat product; the number of slices per minute; the characteristics of the crusted perimeter cooled product, including the perimeter fat layer, or fully tempered equilibrated temperature of the meat product being sliced; whether the meat has been injected; the thickness of the cutting blade; the sharpness of the cutting blade; the temperature of the cutting blade; the hardness of the cutting blade; the friction coefficient of the cutting blade; the friction coefficient of the surface on which the meat product rests on before, after and/or during cutting of the meat product; the shape of the cutting edge or teeth on the cutting blade; whether the cutting blade and/or resting surface for the meat product is kept clean and/or lubricated by, e.g., misting or flushing water on the cutting blade and/or resting surface; the ambient temperature; and the like.

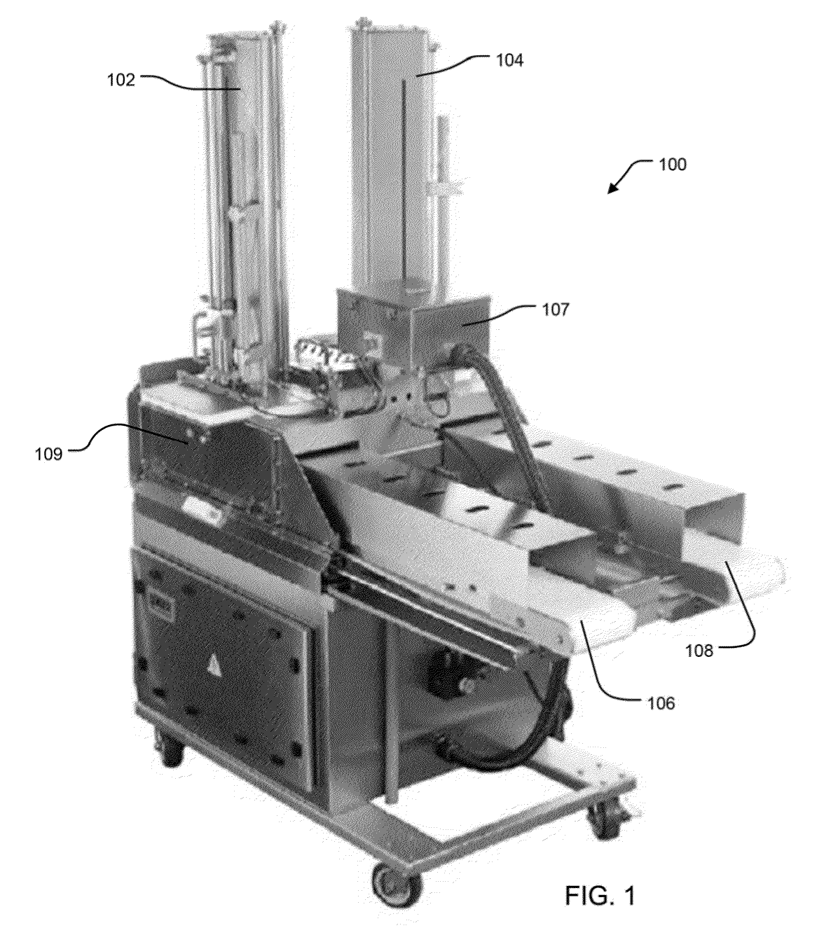

FIG. 1 shows an example of a slicer 100, according to principles of the disclosure. The slicer 100 includes a pair of vertical primal chutes 102, 104, for supplying the primal to a cutting area (not shown), a pair of conveyors 106, 108, for carrying sliced meat products from the cutting area, a pneumatic control box 107, which includes an emergency stop push button for safe, reliably fast operation, and a cutting area housing 109 for enclosing the cutting area. Accordingly, a meat primal may be placed in one or more of the vertical chutes 102, 104, and fed into the cutting area. The slice thickness of the resultant meat product may be adjustable prior to, during, or after operation of the slicer 100.

The slicer 100 includes at least one variable-speed cutter motor (not shown) and at least one variable speed conveyor motor (not shown) (or a fixed speed motor with a drive system set to an optimal speed for the products to be processed or sliced) to allow an operator to match the performance of the slicer 100 with the process requirements. The result is a uniformly thick meat product that maximizes yields, facilitates packing and increases line efficiency.

The slicer 100 is an excellent solution for, e.g., slicing uniformly thick portions of crust chilled or tempered bone-in meat products, including, e.g., pork, beef, lamb, chicken, and the like. The slicer 100 produces a precise, high-quality cut with minimal smear, curl, bone dust or bone chips. The result is a clean cut meat product face. The slicer 100 is simple to operate.

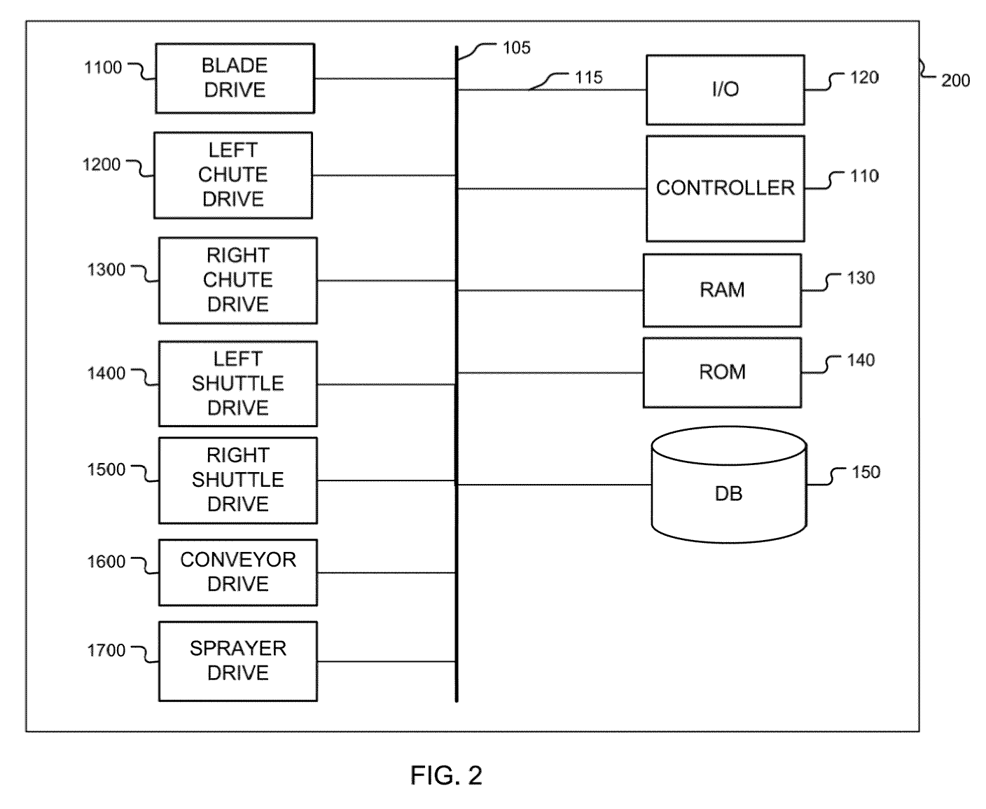

FIG. 2 shows an example of a schematic of a slicer system 200, which may be used in the slicer 100 of FIG. 1, according to principles of the disclosure. The slicer system 200 include a controller 110, an input/output (I/O) interface 120, a random access memory (RAM) 130, a read only memory (ROM) 140, a database (DB) or data store 150, a blade drive 1100, a left chute drive 1200, a right chute drive 1300, a left shuttle drive 1400, a right shuttle drive 1500, a conveyor drive 1600, and a sprayer drive 1700, all of which are interconnected by a bus 105 through a plurality of links 115. The bus 105 facilitates bidirectional (or unidirectional) communication between any one or more of the components 110 through 1700, shown in FIG. 2. The bus 105 may include a busbar, wire(s), a printed circuit conductor, or the like. Alternatively (or additionally), the controller 110 may be directly connected to each of the components 110 through 1700 in FIG. 2, without a bus 105. The linear motions controlled by this logic scheme may be driven by, e.g., an electric linear actuator, a rack-and-pinion system, a cylinder, or the like. In the case of a cylinder-based driver, the cylinder may include, e.g., gas (e.g., air, or the like) or fluid (e.g., hydraulic fluid, or the like). Further, the cylinder-based driver may include, e.g., pneumatic cylinders and valves to regulate movement for desired cutting rate and quality. If pneumatic cylinders and/or valves are used to operate and regulate the slicing motion in cold processing environments, a coalescing oil/water removing filter may be included to prevent icing of the components, thereby delivering a more reliable slicer 100.

The controller 110 may include a computer or a program logic controller (PLC). The computer (or PLC) may include any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a personal computer, a laptop computer, a palmtop computer, a notebook computer, a desktop computer, a workstation computer, a server, or the like, or an array of processors, microprocessors, central processing units, general purpose computers, personal computers, laptop computers, palmtop computers, notebook computers, desktop computers, workstation computers, servers, or the like. The controller 110 may be connected to a server (not shown), which may control or regulate the operation of other meat product processing equipment, such as, e.g., tenderizers, packagers, and the like.

The controller 110 may also be connected to a network (not shown) through the I/O interface 120. The network may include, but is not limited to, for example, any one or more of a personal area network (PAN), a local area network (LAN), a campus area network (CAN), a metropolitan area network (MAN), a wide area network (WAN), a broadband network (BBN), the Internet, or the like. Further, the network may include, but is not limited to, for example, any one or more of the following network topologies, including a bus network, a star network, a ring network, a mesh network, a star-bus network, tree or hierarchical network, or the like.

The I/O interface 120 may be connected to a display (not shown), audio output devices, and a user input device. The display may include a human-machine interface (HMI), such as, e.g., a touch-screen (or touch sensitive) display. The audio output devices may include, e.g., one or more speakers. The user input device may include, e.g., a touch-screen display, a keyboard, a mouse, a microphone, and the like.

The blade drive 1100 may include a variable speed electric motor (not shown), such as, e.g., a stepper motor, a variable frequency driven (VFD) motor, a vector regulated alternating current (AC) induction motor, or the like. The blade drive 1100 is configured to drive the at least one cutting blade 135, such as, e.g., by rotating the cutting blade(s) 135 to slice meat products. The blade drive 1100 may vary the speed at which the cutting blade 135 moves (e.g., rotates). In this regard, the blade drive may communicate with the controller 110 to receive blade drive control signals from the controller 110, as well as send blade drive and cutting blade status signals to the controller 110. The blade drive 1100 may also move the at least one cutting blade 135 in a direction perpendicular to the plane of rotation of the cutting blade(s) 135, so as to adjust the thickness of the resultant sliced meat product.

The blade drive status signals may include, e.g., an error code signal that indicates a malfunctioning or broken part in the blade drive 1100. The cutting blade status signals may include, e.g., a real-time temperature of the cutting blade 135. The blade drive control signals may include timing signals, speed signals (e.g., RPM of cutting blade 135), height (or thickness) signals (e.g., slicing height of the cutting blade 135, which determines the thickness of the sliced meat product), and the like.

The left and right chute drives 1200, 1300, and the left and right shuttle drives 1400, 1500, each may include, e.g., a motor, a piston-manifold assembly, or the like, or any combination thereof. The electric motor may include, e.g., a variable speed motor. The piston-manifold assembly may operate using pressurized gas (e.g., air, nitrogen, or the like) or liquid (e.g., oil, mineral oil, hydraulic fluid, glycol, or the like).

The left and right chute drives 1200, 1300, may communicate with the controller 110 to receive left and right chute control signals to control the vertical chutes 102, 104 (shown in FIG. 1), for optimal meat product delivery, as well as send left and right chute status signals to the controller 110, indicating a status of each of the vertical chutes 102, 104, and/or the left and right chute drives 1200, 1300. The left and right chute control signals may include, e.g., timing signals, speed signals, position signals, and the like. The left and right chute status signals may include, e.g., the real-time position of the respective chute, the speed of the respective chute, a jam condition alert, and the like.

The left and right shuttle drives 1400, 1500, may communicate with the controller 110 to receive left and right shuttle control signals to control the left and right shuttles (not shown) for optimal shuttling of meat products, as well as send left and right shuttle status signals to the controller 110, indicating a status of each of the shuttles and/or the left and right shuttle drives 1400, 1500. The left and right shuttle control signals may include, e.g., timing signals, speed signals, position signals, and the like. The left and right shuttle status signals may include, e.g., the real-time position of the respective shuttle, the speed of the respective shuttle, a jam condition alert, and the like. Isolating the chute from the slicing operation results in a safer operation when the chute is being reloaded by, e.g., an attendant.

The conveyor drive 1600 is configured to drive the conveyors 106, 108 (shown in FIG. 1), each of which may include a conveyor belt, a conveyor mesh, or the like. The conveyor drive 1600 may include at least one motor (not shown) and/or a drive mechanism (not shown). The motor may include, e.g., an electric variable speed motor, a stepper motor, a servo drive motor, or the like. The conveyor drive 1600 may communicate with the controller 110 to receive conveyor drive control signals to drive or move the conveyors 106, 108, such as, e.g., timing signals, speed signals, and like. The conveyor drive 1600 may send conveyor drive status signals to the controller 110, such as, e.g., a real-time speed signal, a timing signal, an error condition signal (e.g., a motor or belt failure), or the like, regarding the conveyor drive 1600, and/or the conveyors 106, 108.

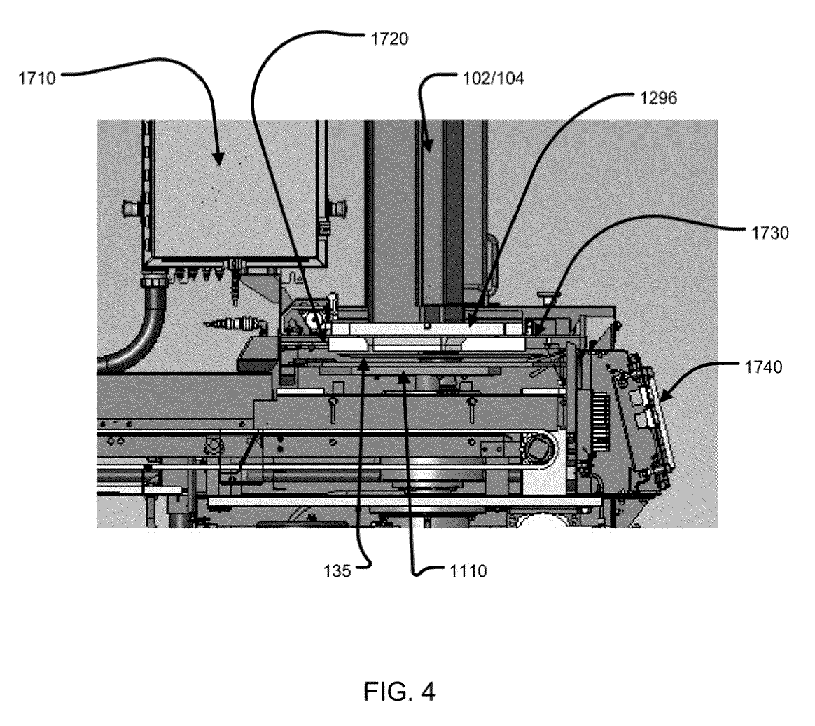

The sprayer drive 1700 may communicate with the controller 110 to drive a pump and one or more valves to supply fluid to one or more jets (or nozzles) via one or more spray manifolds 1720, 1730 (shown in FIG. 4). The pump may be configured to receive a fluid (e.g., a gas or a liquid) from a supply line and output the fluid under pressure (e.g., at a pressure greater than atmospheric pressure, such as, e.g., between about 60 psi and 90 psi) to the one or more jets. The flow and rate of flow of the fluid may be controlled by one or more valves positioned downstream from the pump and/or positioned upstream from the pump. The pump, valves, and/or manifolds 1720, 1730, may be configured to vary the pressure and/or the amount of output fluid in units of, e.g., milliliters-per-second (ml/s) or cubic-centimeters per second (cm³/s). The sprayer drive 1700 may communicate with the controller 110 to receive sprayer drive control signals to drive the pump, valves and/or sprayer manifolds 1720, 1730, as well as send sprayer drive status signals regarding the status of the pump, valves, manifolds 1720, 1730, and/or jet(s). The sprayer drive control signals may include, e.g., a pressure value, a flow rate value, an ON/OFF signal, and a timing value. The sprayer drive status signals may include, e.g., a real-time pressure value, a real-time flow rate value, a temperature value, a valve ON/OFF status value, and an error condition (e.g., seized or malfunctioning pump). The fluid being pressurized and sprayed through the nozzles can be potable water, a processing acid-like surface anti-microbial fluids, a pork bone darkening retardant (e.g., citric acid, brine, or the like), a flavor enhanced solution (e.g., a salt solution, or the like) to impact the final served product taste, a preservative that can extend shelf life, or the like.

Prior to cutting, a meat primal may be chilled to a deep crust chill (e.g., about 22° to about 30° F. at ¼″ to ½″ into the meat primal, with an internal temperature at about 32° to about 38° F.). Alternatively, the meat primal may be fully tempered (e.g., an equilibrated internal meat primal temperature between about 18° to about 32° F.). The chilling or tempering further facilitates reducing smear on the cutting surface of the cutting blade, since colder fat layers tend to smear less when cut, resulting in enhanced or better appearance of the sliced meat product.

By regulating the variable speed drive on the cutting blade 135 and drive motor, operation of the slicer 100 may be optimized, including the slicing rate for the particular type of meat product being cut, the temperature of the meat product, the ambient (or room) temperature, and the like.

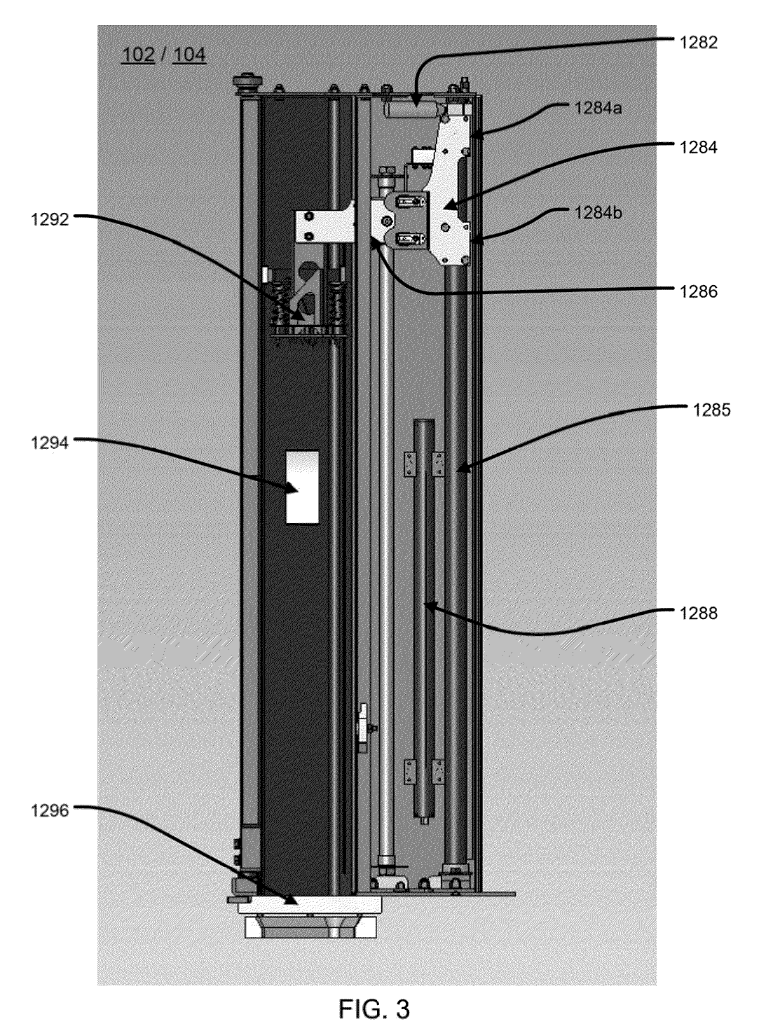

FIG. 3 shows an example of a vertical primal chute 102 (or 104), according to principles of the disclosure. The vertical primal chute 102 (or 104) provides even, smooth down pressure to better retain the primal for high quality, high speed slicing. The vertical primal chute 102 includes an adjustable stroke positioner 1282, a bridge plate 1284, a pneumatic cylinder 1286, a linear transducer 1288, a product follower 1292, and a trap door 1296. As seen in FIG. 3, a primal 1294 may be positioned automatically by, e.g., a spring (not shown) provided in the chute 102 or on a chute door (not shown), which may be interlocked mechanically by a position of the trap door 1296. The adjustable stroke positioner 1282 may include a built-in stroke dampener. The bridge plate 1284 may include two vertical bearings 1284a, 1284b, that ride on a stiff guide rod 1285, thereby ensuring smooth, bind-proof, low friction travel at consistent speed for the product follower 1292. The pneumatic cylinder 1286 may be a rod-less pneumatic cylinder that drives the bridge plate 1284 at a center floating neutral position. The linear transducer 1288 monitors and controls the vertical position of the primal 1294. The product follower 1292 may be a pressure controlled product follower that uses, e.g., an auto-stripping spring loaded with spikes to control the position and movement of the primal 1294 in the chute 102 (or 104). Closure of the chute door automatically triggers proper positioning of the product follower 1292 on the primal, keeping it vertically aligned for consistent level, high quality slicing.

The linear position sensitive transducer 1288 is configured to provide adjustable downward pressure on the product follower 1292 to keep the force or weight of the primal on the thickness table 1110 constant. In this regard, the linear transducer 1288 may compensate for variations in weight of the primal in the chute 102 (104) as the primal is sliced. The linear transducer 1288 is further configured to, when the primal is completely sliced, quickly return the product follower 1292 to its upper-most position and open the chute door to facilitate the manual reloading of the chute 102 (104).

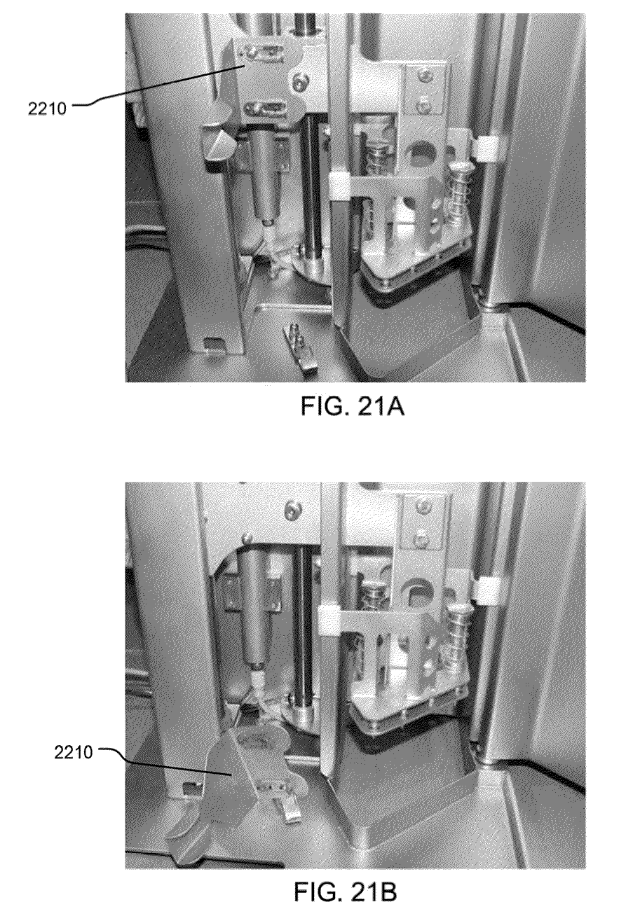

FIGS. 21A, 21B show an example of a detachable handle 2210 in an attached and detached configuration, respectively, that may be used in the vertical chutes 102, 104 of the slicer 100. The removable handle(s) 2210 may be provided in each of the chutes 102, 104, which may be attached (directly or indirectly) to the product follower(s) 1292. The removable handles 2210 may facilitate easier and safer manual positioning of the product follower 1292. The handles 2210 may be configured so that when the product follower 1292 is at the extreme up or down position, no pinch point or hazard results.

FIG. 4 shows an example of a slicing platform system, according to principles of the disclosure. The slicing platform system includes the first spray manifold 1720, the second spray manifold 1730, a Human-Machine Interface (HMI) 1740 screen, the cutting (or slicing) blade 135, and a thickness table 1110. As seen in FIG. 4, the slicing platform is configured proximate the trap door 1296 of the vertical chute 102 (or 104), and a high speed pneumatics enclosure 1710. The primal 1294, which is contained and controlled in the interlocked vertical chute 102 (or 104), is provided to the slicing platform system through the trap door 1296, which allows product feed, e.g., only when the chute door (not shown) is closed. The cutting blade 135, which maybe in a fixed position during cutting, may be configured to slice alternating sides (e.g., product supplied from chute 102 or chute 104) while the product drops to the belt below (not shown). The thickness table 1110, which supports the primal 1294 while it is being sliced by the cutting blade 135, is configured to move in a direction substantially parallel with the longitudinal axis of the chutes 102, 104, so as to adjust the thickness of the resultant sliced product. The thickness table 1110 may be a rotatable crescent shaped (or similarly configured) platform that regulates the thickness of the meat product.

The first spray manifold 1720 may supply pressurized fluid (e.g., water, cold nitrogen gas, processing acid fluid, or the like) to one or more spray jets (not shown), which may be positioned to lubricate, wash, and/or sanitize the cutting blade 135 and the thickness table 1110. The spray from the one or more spray jets may be directed to a scupper (not shown) and catch pan (not shown). The spray may be intermittently supplied (e.g., from about 10% to about 45% of the cutting time) at a pressure of, e.g., between about 60 psi and about 90 psi.

The second spray manifold 1730 may supply pressurized fluid (e.g., water, nitrogen gas, processing acid fluid, or the like) to one or more additional spray jets (not shown), which may be positioned to wash and/or sanitize the top and bottom of the cutting blade 135 and the thickness table 1110 between chutes. The spray may be intermittently supplied (e.g., from about 10% to about 45% of the cutting time—more preferably, between about 20% and about 35% of the cutting time) at a pressure of, e.g., between about 60 psi and 90 psi.

The cutting blade 135 may be coated with a synergistic infused matrix coating, such as, e.g., an Endura® 203x3 coating, an Endura® 202P coating, Armoloy XADC® or the like, which provides a harder surface, reduces the coefficient of friction, provides a release coating, and improves the surface corrosion resistance of the cutting blade 135. The cutting blade 135 may be polished to a lapped “mirror smooth” micro-finish, which resists fat build-up and provides an easy to clean surface on which water may bead. The cutting blade may include, e.g., sharpened, serrated edges, fine saw-teeth, smooth tapered radial ribbing, slight beveling (including, e.g., the use of Grantons), and/or the like, to provide for slicing through, e.g., internal bones in the meat product without fracturing or splitting the bone. The cutting blade should be configured to be able to cleanly slice meat product without smear for, e.g., at least 240 minutes, preferably 480 minutes before cleaning of the cutting blade may become necessary. The use of the intermittent misting or SIM mode facilitates this extended run time for bone-in pork loins (injected or non-injected) meat products.

The synergistic infused matrix coating may include, e.g., a nickel alloy matrix with the controlled infusion of sub-micron sized particles of high temperature, low friction polymers. The coating is an integral part of the surface base metal of the cutting blade. The cutting blade, including the synergistic infused matrix coating, possesses an exceptional combination of nonstick, non-wetting, low friction, corrosion resistance, wear resistance and hardness properties.

The synergistic infused matrix coating comprises a coating thickness of, e.g., about 0.001 (±0.0003) inches, a maximum operating temperature of, e.g., about 500° F. continuous, a coefficient of thermal expansion of, e.g., about 14 μm/m/° C., a modulus of elasticity of, e.g., about 2.0×10⁵ N/mm², a hardness (Rockwell C) of, e.g., about 62 to 68, a taber abrasion resistance of, e.g., about 0.03 g, a salt spray (5% per ASTM B117) resistance of, e.g., about 1500+h, a friction coefficient, dynamic/static of, e.g., as low as 0.06/0.08, but, e.g., 0.175, or lower dry. The synergistic infused matrix coating delivers excellent release (non-stick), dry film lubrication, base material compatibility (ferrous and non-ferrous metals), and chemical resistance (ASTM D543) characteristics. The coating is FDA/USDA compliant and comprises a durable, non-flaking metallic finish.

Further, the synergistic infused matrix coating may comprise a coating thickness of, e.g., about 0.0003 to about 0.0005 inches, a modulus of elasticity of, e.g., about 2.0×10⁵ N/mm², a hardness (Rockwell C) of, e.g., between about 54 and 85 (a Rockwell C value in the range of about 62 to about 68 may be optimal for most products), a taber abrasion resistance of, e.g., about 0.03 g, a salt spray (5% per ASTM B117) resistance of, e.g., about 1500+h, a coefficient of friction value, dynamic/static as low as, e.g., 0.02/0.04 dry, a surface energy of, e.g., about 14 to 18 dyne-cm. A hardness (Rockwell C) of, e.g., between about 54 and 85, should give a longer blade life without the need to resharpen it.

Still further, the coating may comprise a new generation coating, such as, e.g., PenTuf®/En and/or EN/PenTuf® Infused coatings. The PenTuf®/En coating may be applied to stainless steel, aluminum, titanium, brass, copper, or steel. The PenTuf®/En coating may have a thickness of, e.g., about 0.0001″ to 0.0003″. The EN/PenTuf® Infused coating may be applied by microcracking “as plated” electroless nickel at high temperatures (e.g., about 550° to about 700° F.) and infusing polytetrafluroethylene (PTFE) into the resultant cracks.

Still further, the coating may comprise, e.g., a Nedox® coating, a Plasmadize® coating, a Goldenedge® coating, a BryCoat™ Titanium Carbo-Nitride coating, an Armoloy® TDC Thin Dense Chromium Finish coating, a Wearalon® coating, or the like.

The other parts of the slicing platform system, such as, e.g. the thickness table 1110, may also be coated with the synergistic infused matrix coating, such as, e.g., Endura 203x3, and polished to a “mirror smooth” micro-finish. For example, the resting surfaces upon which the meat product will ride on may be coated with the synergistic infused matrix coating and polished to a “mirror smooth” micro-finish.

The slicing platform system may include an eccentric cutter drive (not shown) that, together with a moving resting surface, minimizes the resting surface that comes into contact with the meat product. The eccentric cutter drive and moving resting surface essentially suspend the meat product in air as it is sliced off the primal.

The slicing platform system may include a cooling mechanism to keep the cutting blade 135 within a predetermined temperature range, such as, e.g., between about 25° and about 55° F., and more preferably between about 33° and about 38° F., or the like. For example, the cooling mechanism may include a cooling fluid supply source (not shown), sprayer manifolds 1720, 1730 (e.g., shown in FIG. 4), and a plurality of jets or nozzles. The plurality of jets may keep the cutting blade 135 within a predetermined temperature range (e.g., between about 25° and about 55° F.) by applying a fluid (e.g., water, nitrogen gas, cold air, or the like) at, or near freezing temperature (e.g., 33° F.).

Additionally (or alternatively) the cooling mechanism may include, e.g., refrigeration, “dry ice” (Cryogenic CO₂/N₂; e.g., about 85% to about 94% hard ice), and the like. For example, a sub-freeze nitrogen gas or cold air may be forced into the cutting area of the slicer 100, to maintain the cutting blade 135, as well as the surrounding area within a predetermined temperature range (e.g., between about 25° and about 55° F.).

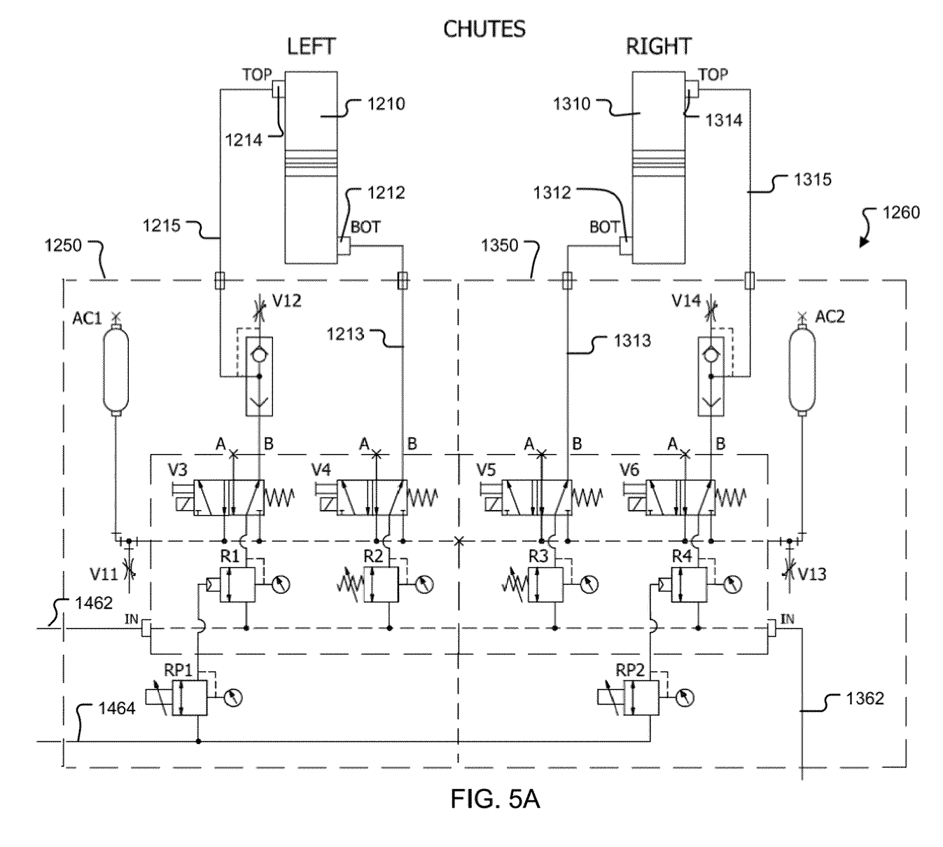

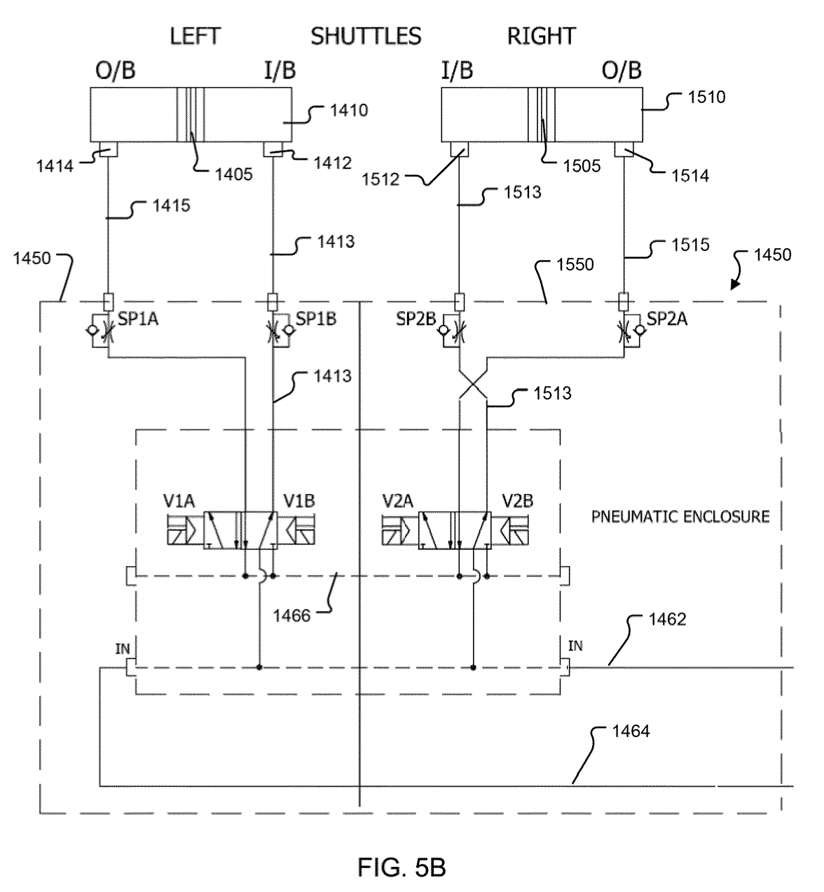

FIG. 5A shows an embodiment of a pair of chutes 1210, 1310, and chute drive sections 1250, 1350, according to principles of the disclosure. The chutes 1210, 1310, may each include a dual-port piston driven conveyor 1205, 1305, respectively. The chute drive sections 1250, 1350, may be provided (or encased) in a pneumatic enclosure, which includes a chute manifold 1260.

The chute 1210 includes a bottom (BOT) port 1212 that is coupled to a left chute bottom line 1213, and a top (TOP) port 1214 that is coupled to a left chute top line 1215. Similarly, the chute 1310 includes a bottom (BOT) port 1312 that is coupled to a right chute bottom line 1313, and a top (TOP) port 1314 that is coupled to a right shuttle top line 1315.

The chute manifold 1260 includes the left chute drive section 1250 and the right chute drive section 1350. The left chute drive section 1250 includes a left chute down pressure control valve R1, a left chute go up pressure control valve R2, a left chute down pressure pilot valve RP1, a left chute go up valve V3, a left chute go down valve V4, a left chute down speed control valve V11, a left chute up speed control valve V12, and a left chute jump start accumulator AC1. The right chute drive section 1350 includes a right chute down pressure control valve R4, a right chute up pressure control valve R3, a right chute down pressure pilot valve RP2, a right chute go up valve V6, a right chute go down valve V5, a right chute down speed control valve V13, a right chute up speed control valve V14, and a right chute jump start accumulator AC2.

The valves V3, V4, V5, and V6 are coupled to lines 1215, 1213, 1313, and 1515, respectively. The valves V3, V4, V5, and V6 are also coupled to supply lines 1362, 1462, through pressure regulation valves R1, R2, R3, and R4, respectively. Valves R1, R4, are coupled to and controlled by the valves RP1, RP2, respectively. The supply line 1362 may be coupled to a fluid supply (gas or liquid), such as, e.g., an air supply line. The fluid may be provided at pressures substantially greater than atmospheric pressure, such as, e.g., 90 PSI, or greater where the fluid is air or CO₂.

FIG. 5B shows an embodiment of a pair of shuttles 1410, 1510, and associated shuttle drive sections 1450, 1550, according to principles of the disclosure. The shuttles 1410, 1510 are provided for operator safety and to isolate the meat product from, e.g., the water flush cycle (SIM), which may be important for, e.g., the European Community, which wants to keep water isolated from the product being sliced. The shuttles 1410, 1510, may each include a dual-port piston driven conveyor 1405, 1505, respectively. The shuttle drive sections 1450, 1550, may be provided (or encased) in the pneumatic enclosure 1710 (shown in FIG. 4), which includes a shuttle manifold 1460. The chute manifold 1260 (FIG. 5A) and the shuttle manifold 1460 may be formed as a single manifold, or separate manifolds.

As seen in FIG. 5B, the shuttle 1410 includes an inboard (I/B) port 1412 that is coupled to a left shuttle supply line 1413, and an outboard (O/B) port 1414 that is coupled to a left shuttle output line 1415. Similarly, the shuttle 1510 includes an inboard (I/B) port 1512 that is coupled to a right shuttle supply line 1513, and an outboard (O/B) port 1514 that is coupled to a right shuttle output line 1515.

The manifold 1460 includes the left shuttle drive section 1450 and the right shuttle drive section 1550. The left shuttle drive section 1450 includes a left shuttle inboard speed control valve SP1B and a left shuttle outboard speed control valve SP1A. The right shuttle drive section 1550 includes a right shuttle go inboard speed control valve SP2B and a right shuttle go outboard speed control valve SP2A. The left shuttle drive section 1450 further includes a left shuttle go inboard valve V1A and a left shuttle go outboard valve V1B. The right shuttle drive section 1550 further includes a right shuttle go inboard valve V2A and a right shuttle go outboard valve V2B. The speed control valves SP1A, SP1B, SP2A and SP2B are coupled to lines 1415, 1413, 1515, and 1513, respectively. Further, the valves V1A, V1B, V2A, and V2B are coupled to lines 1415, 1413, 1515, and 1513, respectively. The valves V1A, V1B, V2A, and V2B are also coupled to supply lines 1462, 1464. The supply lines 1462, 1464, may be selectively coupled to one of the lines 1415 or 1413 in the left shuttle drive section 1450, and one of the lines 1513 or 1515 in the right shuttle drive section 1550, under control of a valve control line 1466, thereby placing the supply lines 1462, 1464, in fluid communication with the selected ones of lines 1415 or 1413, and lines 1513 or 1515. The valve control line 1466 is coupled to each of the valves V1A, V1B, V2A, and V2B.

FIG. 6 shows an example of a main menu display screen, according to principles of the disclosure. The main menu may be generated by the controller 110 (shown in FIG. 2) and reproduced via the I/O interface 120 onto a display (not shown). The main menu includes a plurality of selectable modes, including, e.g., but not limited to, a machine setup mode, a SIMS configure mode, an intermittent misting configure mode, a supervisory administration screen mode, an options mode, a manual movement mode, an inputs screen mode, an outputs screen mode, a continuous thickness mode, a continuous run mode, a variable thickness mode, a library screen mode, a language mode, and a security mode. The main menu also includes a data or command entry field for receiving user inputs and/or commands. The security mode includes, e.g., five discrete levels (e.g., 0, 1, 2, 3, 4) of access authorization. As seen, the various modes may be assigned particular access (or privilege) levels, which will only allow users having that particular access (or privilege) level to access the mode. For instance, the machine setup mode may be assigned a security level “2,” which will prohibit all users from accessing the machine setup mode, except for users having a level “2,” or higher security authorization. The supervisory administration mode may be assigned a level “3,” thereby restricting access to the mode by only those who have level “3,” or higher access privileges. The main menu display screen may display a message to the user, such as, e.g., “MUST BE HOMED” and “NOT IN ALTERNATING CHUTE MODE.” The main menu may also include selectable fields for a simultaneous chute mode and an alternating chute mode.

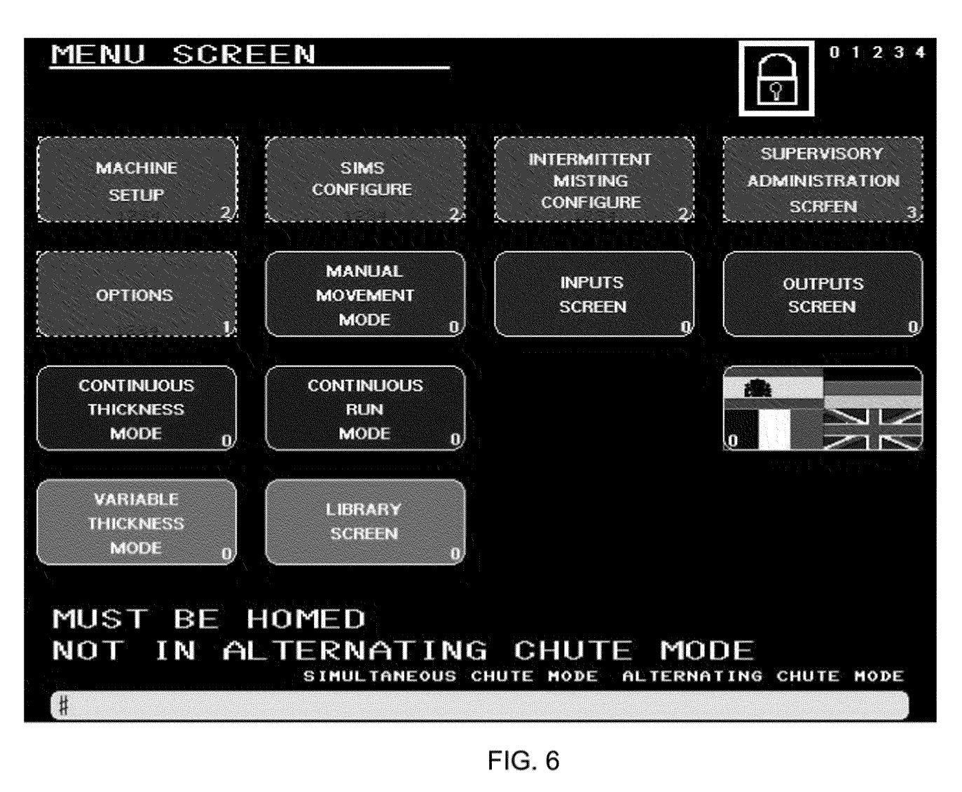

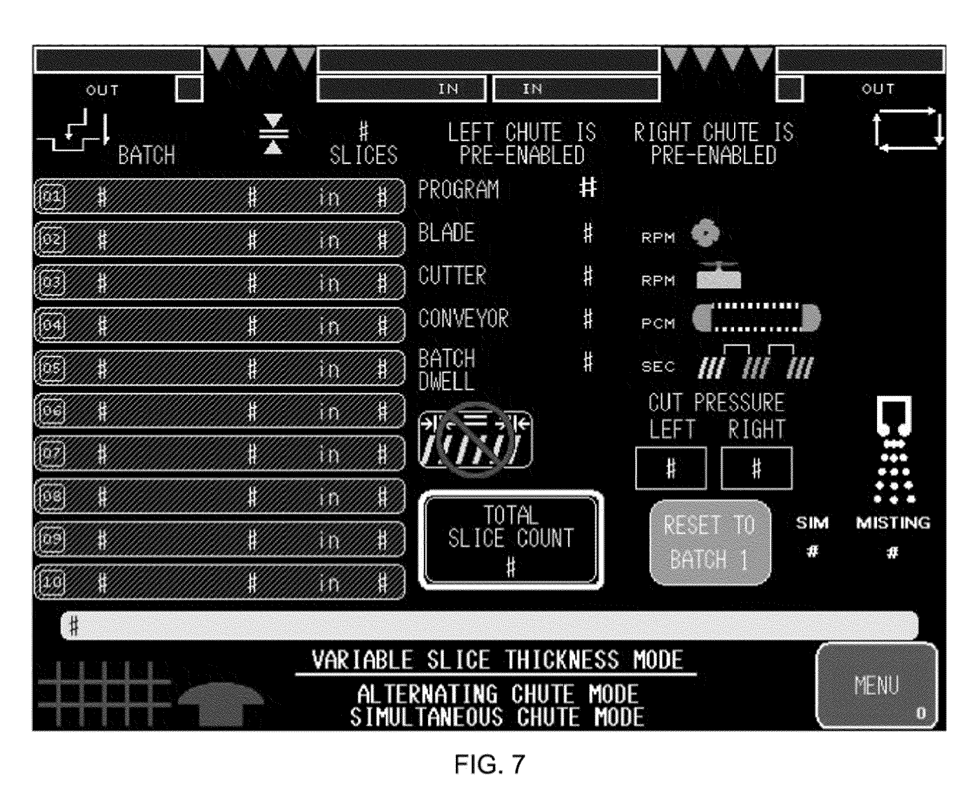

FIG. 7 shows an example of a variable thickness mode display screen, according to principles of the disclosure. As seen in FIG. 7, the variable thickness mode display screen may include a plurality of fields for receiving control parameters, including, but not limited to, e.g., a batch number field, a slice thickness field for each batch number field, a number of slices field for each batch number field, a left chute enablement status field, a right chute enablement status field, a program number field, a blade speed field (in RPM units), a cutter speed field (in RPM units), a conveyor speed field (in PCM units), a batch dwell field (in seconds units), the total slice count field, a left cut pressure field, a right cut pressure field, a SIM number field, a misting status field, a misting number field, a data entry field, an alternating chute mode selection field, and a simultaneous chute mode selection field. Each of the displayed fields may be edited. The variable thickness mode submenu display screen may also include a data or command entry field for receiving data or commands input by a user.

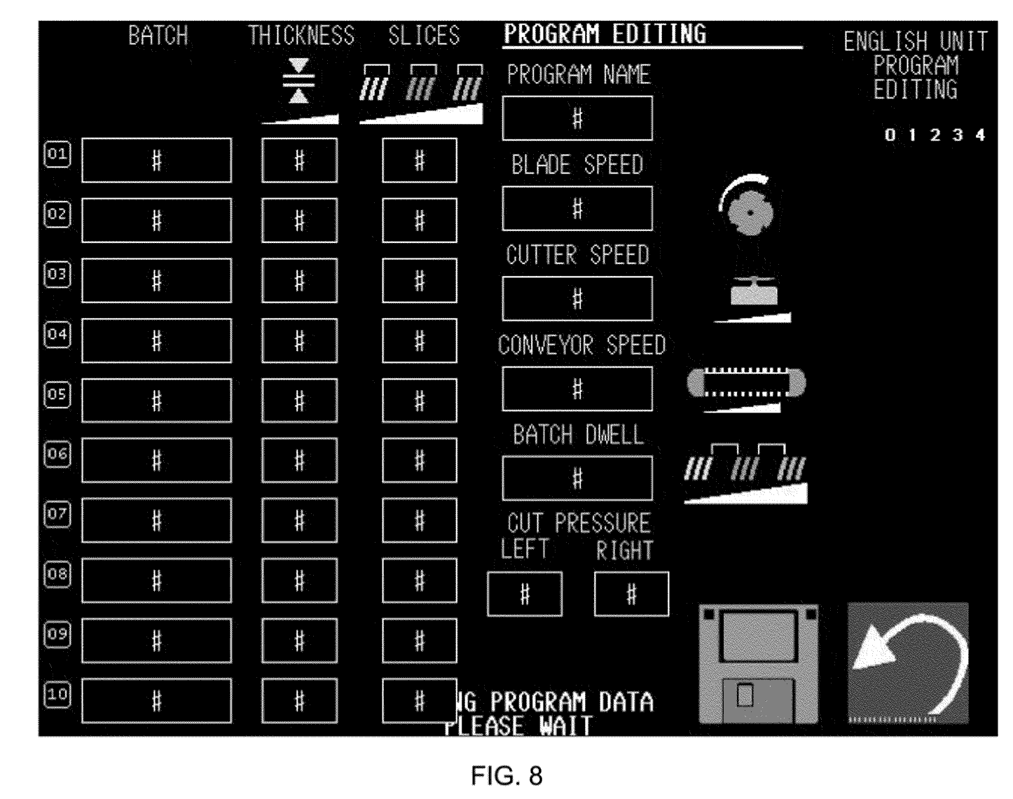

FIG. 8 shows an example of a program editing display screen for the variable thickness mode, according to principles of the disclosure. As seen in FIG. 8, each of the fields disclosed in FIG. 7 may be edited by the user. For example, referring to “01,” the user may input (or select) a batch value, a thickness value, and a number of slices value. The user may similarly input (or select) a batch value, a thickness value, and a number of slices values for each of “02” through “10.” The user may also input (or select) a program name, a blade speed value, a cutter speed value, a conveyor speed value, a batch dwell value, a left cut pressure value, and a right cut pressure value. After inputting the desired values, the values may be saved by selecting the save icon (e.g., diskette icon).

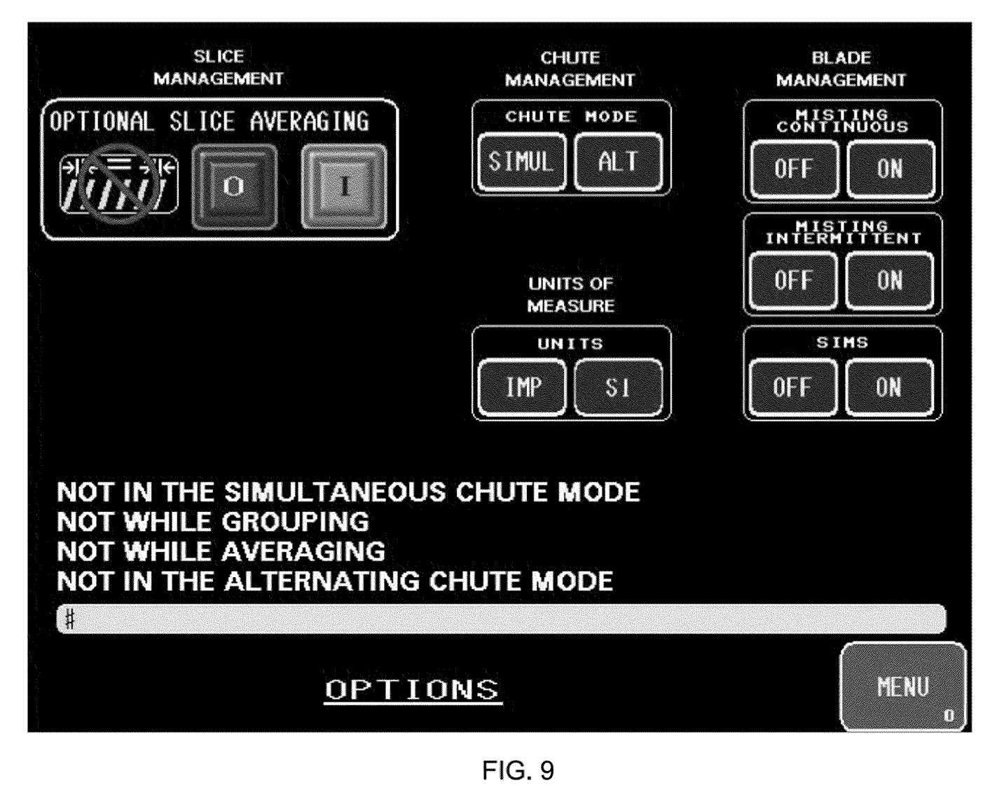

FIG. 9 shows an example of an options mode display screen, according to principles of the disclosure. The options mode includes, but is not limited to, e.g., a slice management submode, a chute management submode, a blade management submode, and a units of measure submode. The options mode display screen may include a data or command entry field for receiving data or commands input by a user. The slice management submode includes a slice averaging enabled and disabled icons and OFF and ON buttons to enable or disable the slice averaging routine. The chute management submode includes a simultaneous chute control icon and an alternating chute control icon for controlling the movement of the chutes, such that the chutes operate in a simultaneous or alternating manner. The units of measure submode includes an Imperial units icon and a metric units icon for selecting the units of measure. The blade management submode includes three separate blade management options, including continuous misting (ON/OFF), intermittent misting (ON/OFF), or SIMS (ON/OFF). The options mode display screen may also include a plurality of selectable options, such as, e.g., a “not in the simultaneous chute mode,” “now while grouping,” “not while averaging,” and/or “not in the alternating chute mode.” The options mode display may further include a data or command entry field for receiving data or commands input by the user.

The SIM cycle may include, e.g.: closing the shutter and isolating the primals in the chutes 102, 104, from the slicing chamber, which includes the cutting area, the cutting blade 135 and the thickness table 1110; directing the thickness table 1110 to a position for cleaning by directing water jets (nozzles) to flush away any deposited fat smear on the cutting blade 135 (e.g., top and bottom of the cutting blade 135) and the thickness table 1110; sending the cleaning water to a scupper, where the fat may be screened from the effluent water, which may be sent to a drain; repositioning the thickness table 1110 for slicing; and resuming the cutting process. The SIM cycle may be configured to initiate and/or terminate automatically at, e.g., an operator selected frequency based on the particular product and slicing speed. The SIM cycle may be configured to last, e.g., about 15 seconds with a 10 second fluid flush. In this regard, water consumption may be configured to be, e.g., about 1.5 gallons per hour (6 liters per hour).

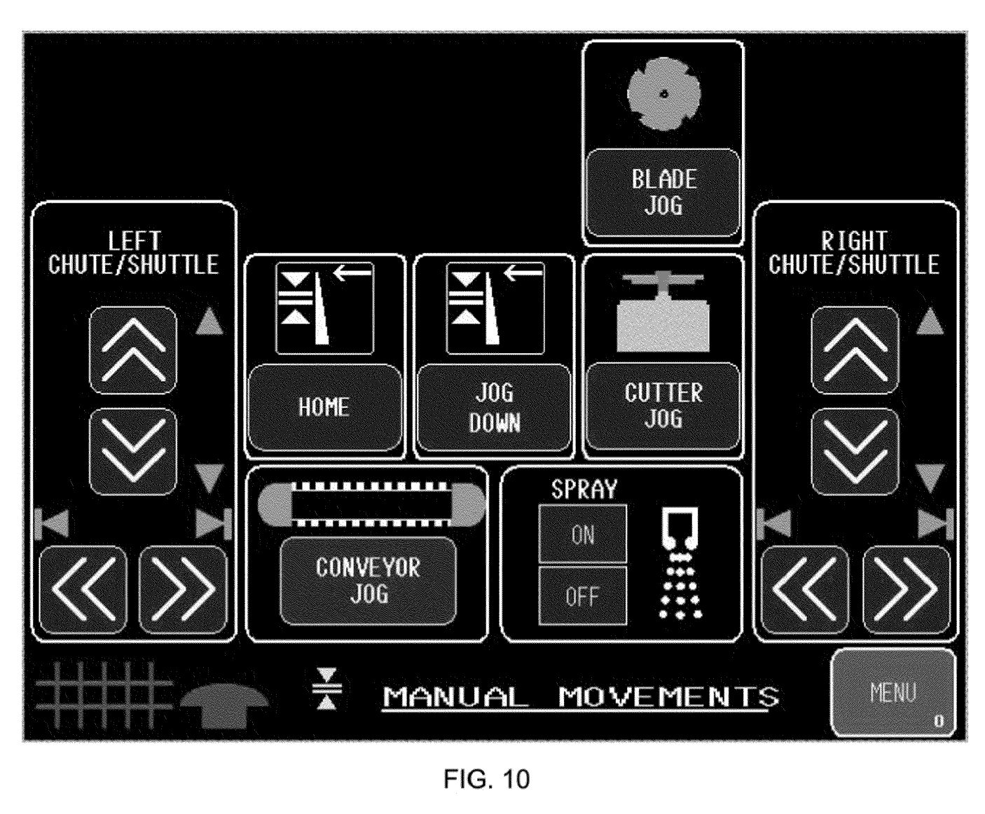

FIG. 10 shows an example of a manual movements mode display screen, according to principles of the disclosure. The manual movements mode includes, but is not limited to, e.g., a blade jog control, a left chute/shuttle control, a right chute/shuttle control, a home control, a jog down control, a cutter jog control, a conveyor jog control, and a spray control. Any one or more of these controls may be manipulated by, e.g., touching an associated icon displayed on, e.g., a touch-screen display (not shown), to manually control the associated chute, shuttle, blade, cutter, conveyor, and/or spray.

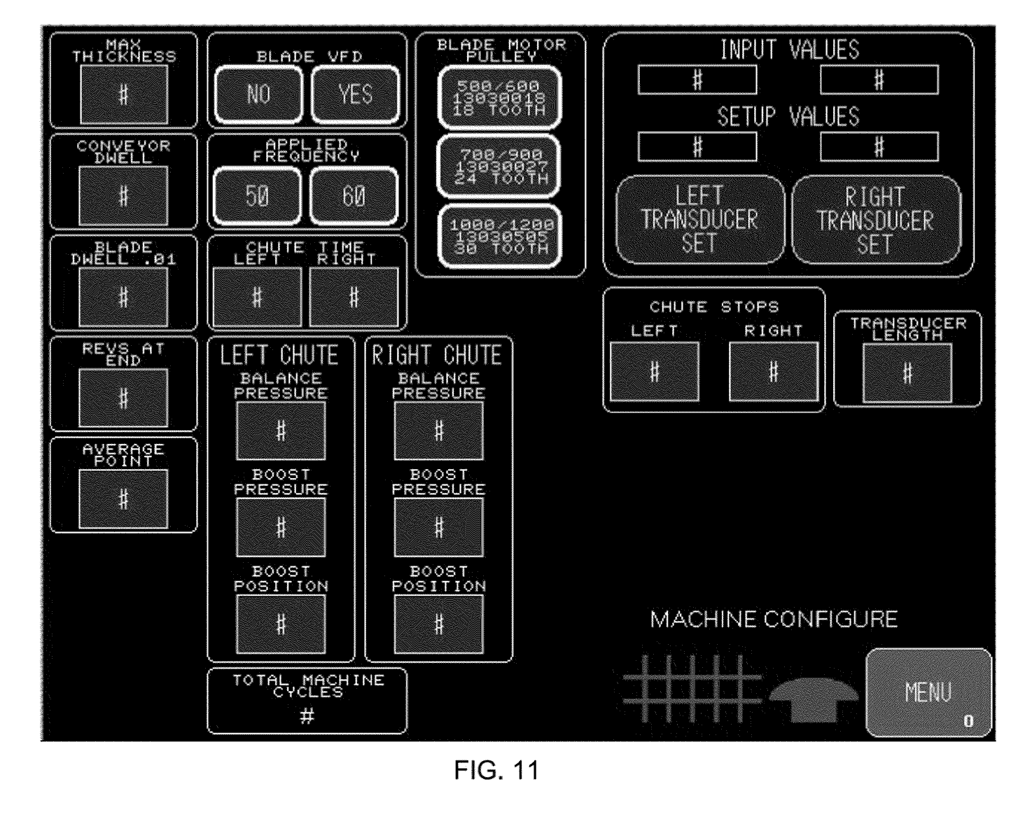

FIG. 11 shows an example of a machine configure mode display screen, according to principles of the disclosure. The machine configure mode includes, but is not limited to, e.g., a maximum thickness value field, a conveyor dwell value field, a blade dwell value field, a revs at end value field, an average point value field, a left chute time value field, a right chute time value field, a left chute balance pressure value field, a left chute boost pressure value field, a left chute boost position value field, a right chute balance pressure value field, a right chute boost pressure value field, a right chute boost position value field, a left chute stops value field, a right chute stops value field, a transducer length value field, a left transducer set input value field, a left transducer set setup values value field, a right transducer set input value field, a right transducer setup values value field, and a total machine cycles value field. The machine configure mode may further include an applied electric frequency selection field (e.g., 50 Hz/60 Hz), a bald VFD selection field (YES/NO), and a blade motor pulley selection field (e.g., 500/600 18 tooth pulley, 700/900 24 tooth pulley, 1000/1200 30 tooth pulley, or the like). By inputting (or selecting) values for the various fields in the machine configure mode, a user can control all of the associated aspects of the slicer 100 (shown in FIG. 1).

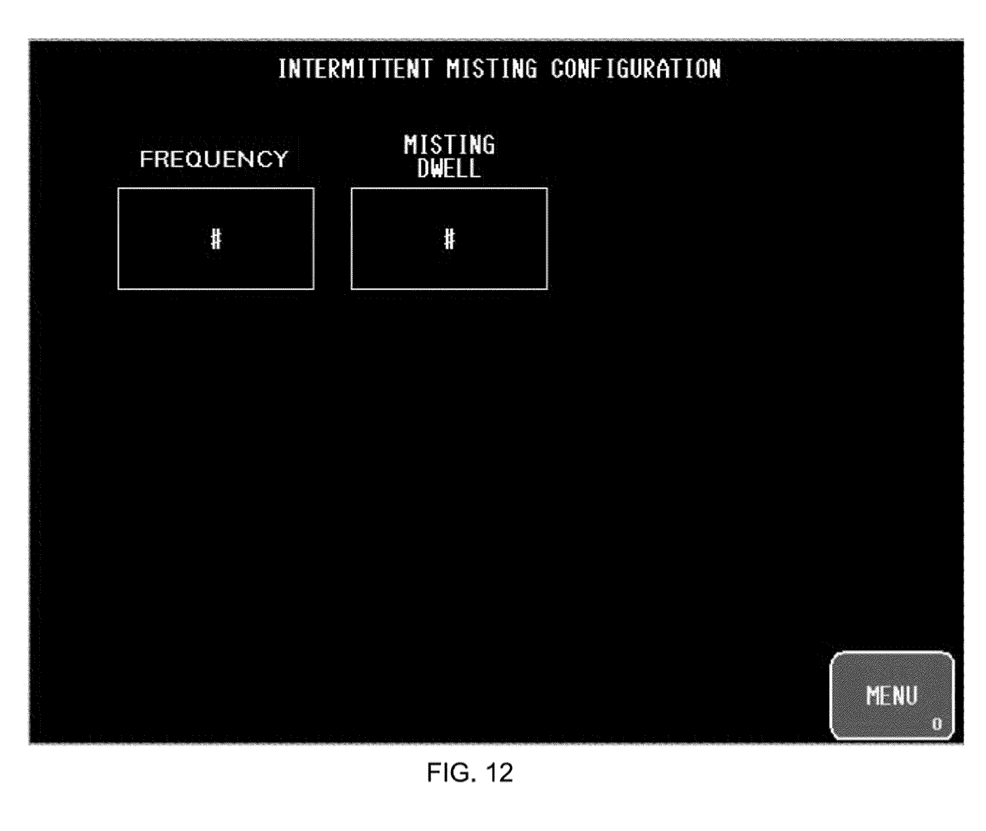

FIG. 12 shows an example of an intermittent misting configuration mode display screen, according to principles of the disclosure. The intermittent misting configuration mode helps regulate water through the lubricating and cleaning nozzles. In this regard, regulation at, e.g., about 15% to about 40% of the cutting time may be ideal for smearless, injected, bon-in pork loin slicing. The intermittent misting configuration mode includes, but is not limited to, e.g., a frequency value field and a misting dwell value field. By inputting (or selecting) values for the frequency and misting dwell, a user can control the amount of mist that is applied for each occurrence, and how frequently the mist is applied to the cutting blade. Accordingly, the cutting blade 135 and thickness table 1110 may be kept moist, thereby lowering their coefficient of friction, which, with, e.g., a typical injected bone-in pork loin, will result in a smearless slicing of the resulting meat products (e.g., pork chops, or the like) at the desired operator selected thickness (or multiple thicknesses) in one product chute loading.

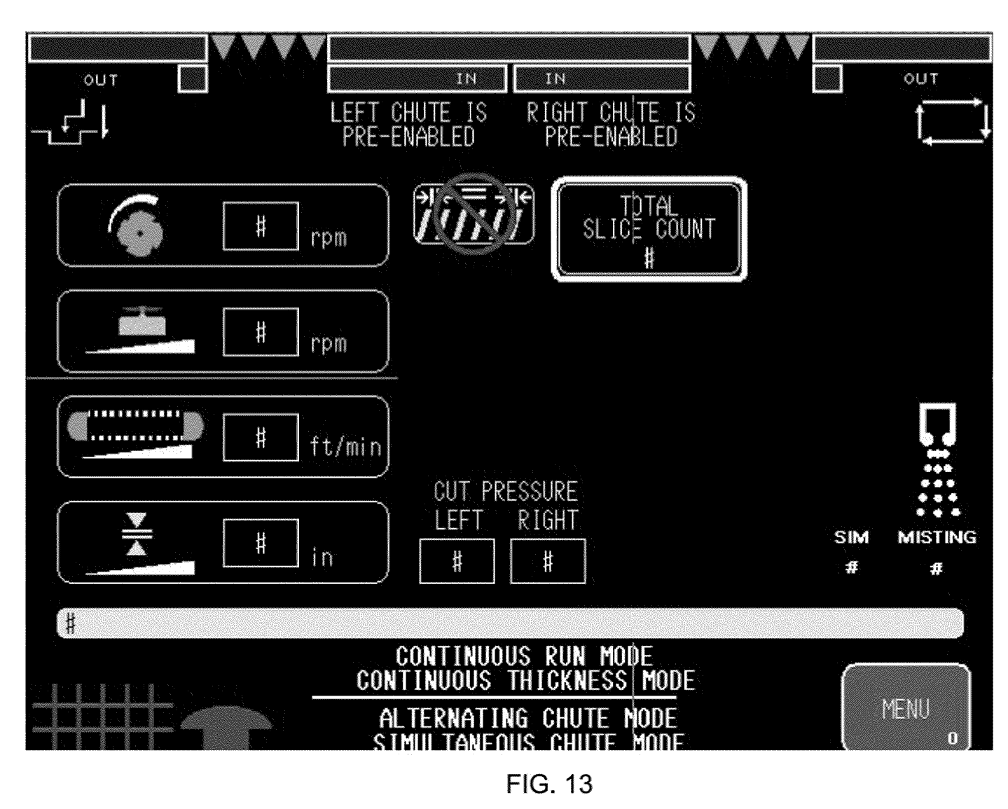

FIG. 13 shows an example of a continuous run mode display screen, according to principles of the disclosure. The continuous run mode includes, but is not limited to, e.g., a blade speed value field (e.g., rpm), a cutter speed value field (e.g., rpm), a conveyor speed value field (e.g., ft/min), a thickness value field (e.g., inches), a left cut pressure value field, a right cut pressure value field, a SIM number status field, a misting number status field, a total slice count status field, a shuttle movement status field, a left chute enablement status field, and a right chute enablement status field. The continuous run mode display screen may include a data or command entry field for receiving data or commands input by the user. For instance, the continuous run mode display screen may include the following selectable options, “CONTINUOUS RUN MODE,” “CONTINUOUS THICKNESS MODE,” “ALTERNATING CHUTE MODE,” and/or “SIMULTANEOUS CHUTE MODE.” By inputting (or selecting) one or more values for the various fields in the continuous run mode display screen, a user can control, e.g., the blade speed, the cutter speed, the conveyor speed, the thickness setting, and the like, during continuous mode operation of the slicer 100 (shown in FIG. 1).

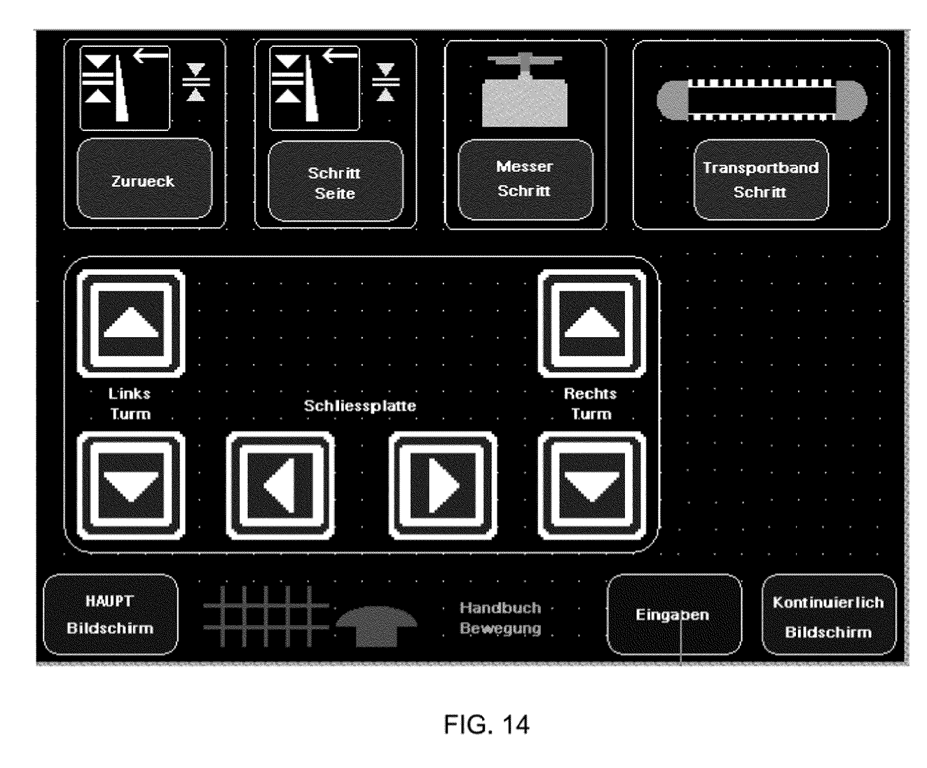

FIG. 14 shows an example of a SIM configuration mode display screen, according to principles of the disclosure.

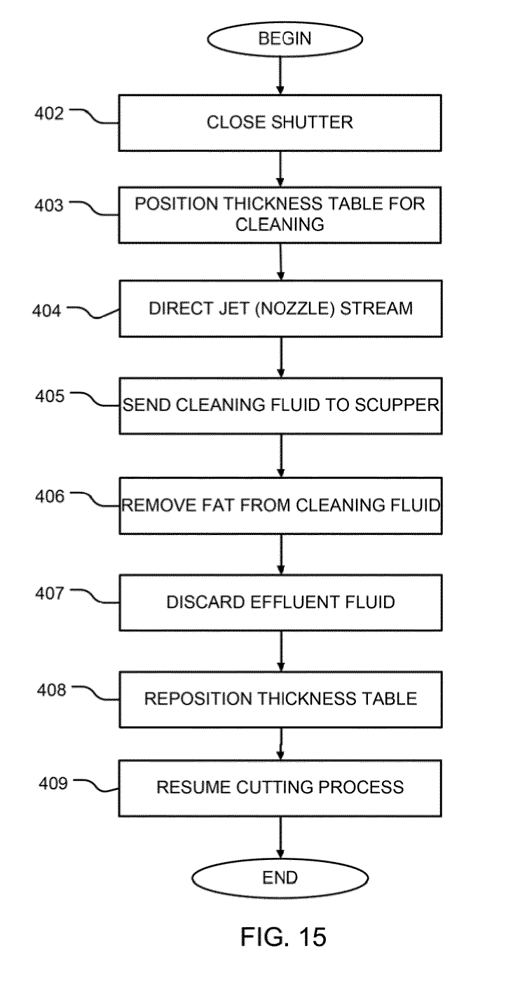

FIG. 15 shows an example of a SIM process (or cycle), according to principles of the disclosure. As seen in FIG. 15, after a primal has been placed in the chute 102 (or 104), the shutter is closed, isolating the primal in the chute 102 from the slicing chamber, which includes the cutting area, the cutting blade 135 and the thickness table 1110 (Step 402). The thickness table 1110 may then be positioned for cleaning of the cutting blade 135 and/or thickness table 1110 (Step 403). The fluid jets (nozzles) may then be directed to flush away any deposited fat smear on the cutting blade 135 (e.g., top and bottom of the cutting blade 135) and the thickness table 1110 (Step 404). The cleaning fluid (e.g., water, or the like) may then be sent to, e.g., a scupper (Step 405). The scupper may then remove the fat (e.g., by screening) from the effluent fluid (Step 406). The effluent fluid may then be discarded by, e.g., sending the fluid to a drain (Step 407). The thickness table 1110 may then be repositioned for slicing (Step 408), and the cutting process may be resumed (Step 409). The SIM cycle may be configured to initiate and/or terminate automatically at, e.g., an operator selected frequency based on the particular product and slicing speed. The SIM cycle may be configured to last, e.g., about 15 seconds with a 10 second fluid flush. In this regard, water consumption may be configured to be, e.g., about 1.5 gallons per hour (6 liters per hour).

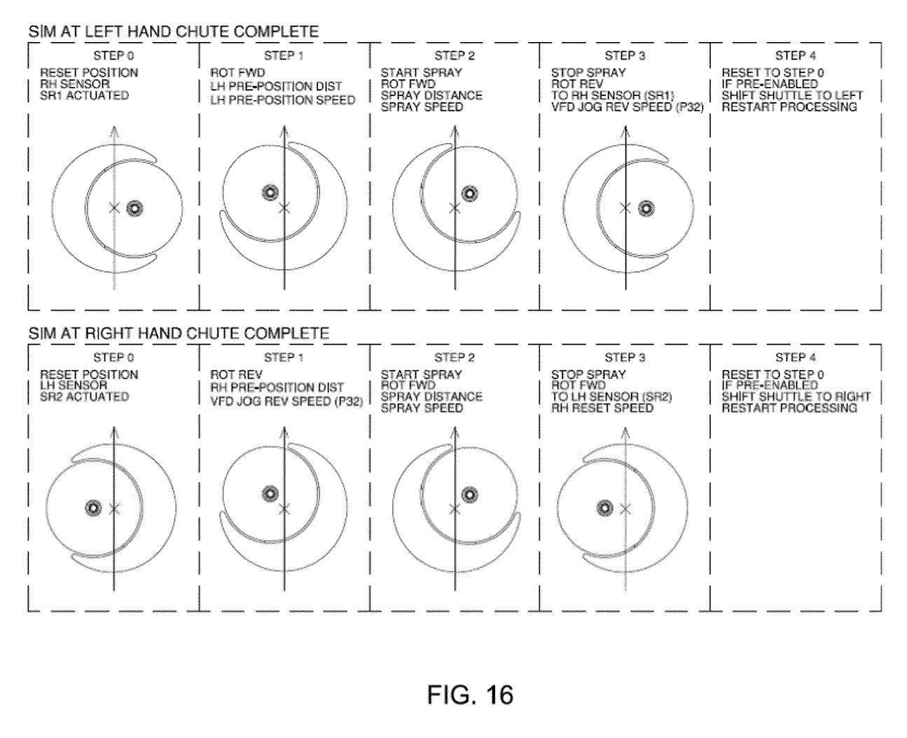

FIG. 16 shows an example of the SIM process for a pair of left and right chutes, according to principles of the disclosure. As seen in FIG. 16, the SIM process may include four steps after each completion of movement of the pair of chutes 102, 104. For example, after the left chute movement is complete (e.g., 102 or 104, shown in FIG. 1), the position of the thickness table 1110 is reset (Step 0), then the cutting blade 135 is rotated forward (Step 1). The jet stream is then activated to spray on the cutting blade 135 and/or thickness table 1110 (Step 2), which is stopped after a predetermined time (Step 3). The shuttle is then shifted, e.g., to the left, and the process is restarted (Step 4). A similar process is carried out after the right chute movement is complete (e.g., 104 or 102, shown in FIG. 1).

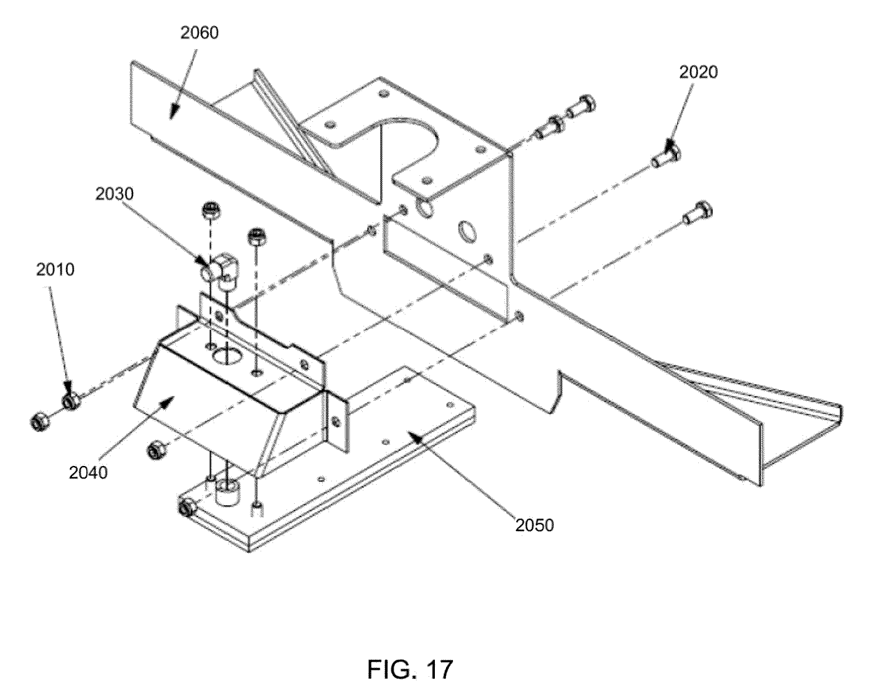

FIG. 17 shows an example of a fluid flush assembly 2000 that may be used in the slicer 100 (shown in FIG. 1), according to principles of the disclosure. The fluid flush assembly 2000 includes fasteners 2010, 2020 (such as, e.g., a bolt-nut combination, a rivet, a lock-and-pin, or the like), a conduit 2030 (e.g., an elbow, or the like), a scupper weldment 2040, a spray plate assembly 2050 and a guard 2060, as shown in FIG. 17.

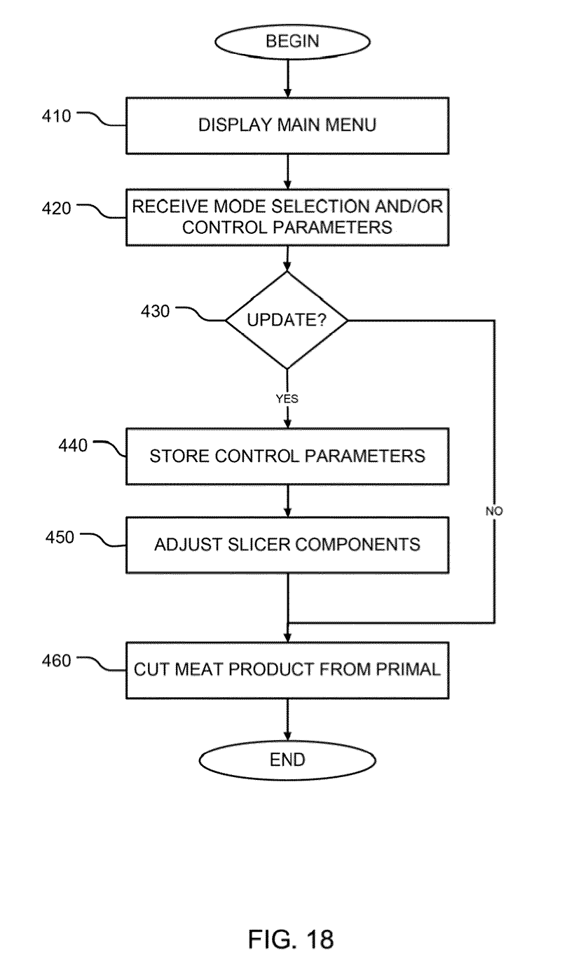

FIG. 18 shows an example of a process for slicing a meat product from a primal, according to aspects of the disclosure.

Referring to FIGS. 2 and 18, the controller 110 generates and displays a main menu screen on a display (e.g., shown in FIG. 6) via the I/O 120 (Step 410). The main menu screen includes a plurality of mode selections, as shown in FIG. 6. The controller 110 receives a selection of one of the plurality of mode selections (Step 420). On the basis of the selected mode and any control parameters provided by the user (e.g., the variable slice thickness mode, shown in FIG. 7), the controller 110 determines whether any of the control parameters have been updated compared to the control parameters stored in the data store 150 (Step 430). The control parameters may include, for example, but are not limited to, a batch number, a meat product thickness, a number of slices, a program number, a cutting blade speed, a cutter speed, a conveyor speed, a batch dwell time, a cut pressure, a SIM cycle, and the like, as shown, e.g., in FIGS. 7-14. If it is determined that the selected mode or control parameters have been updated (“YES” at Step 430), then the controller stores the control parameters in the data store 150 (Step 440) and adjusts the slicer 100 components 1100 through 1700 in FIG. 2 (Step 450) (e.g., the cutter blade speed, the fluid application interval/duration/frequency/amount, the conveyor speed, the chute speed, the shuttle positioning, and the like) based on the selected mode and control parameters. Once adjustment of the slicer 100 components 1100 through 1700 is complete (Step 450), then the meat product may be cut from the primal (Step 460).

If it is determined that the selected mode or control parameters have not been updated (“NO” at Step 430), then the control parameters of the components 1100 and 1700 remain unchanged and the meat product may be cut from the primal based on previously stored values for the control parameters (Step 460).

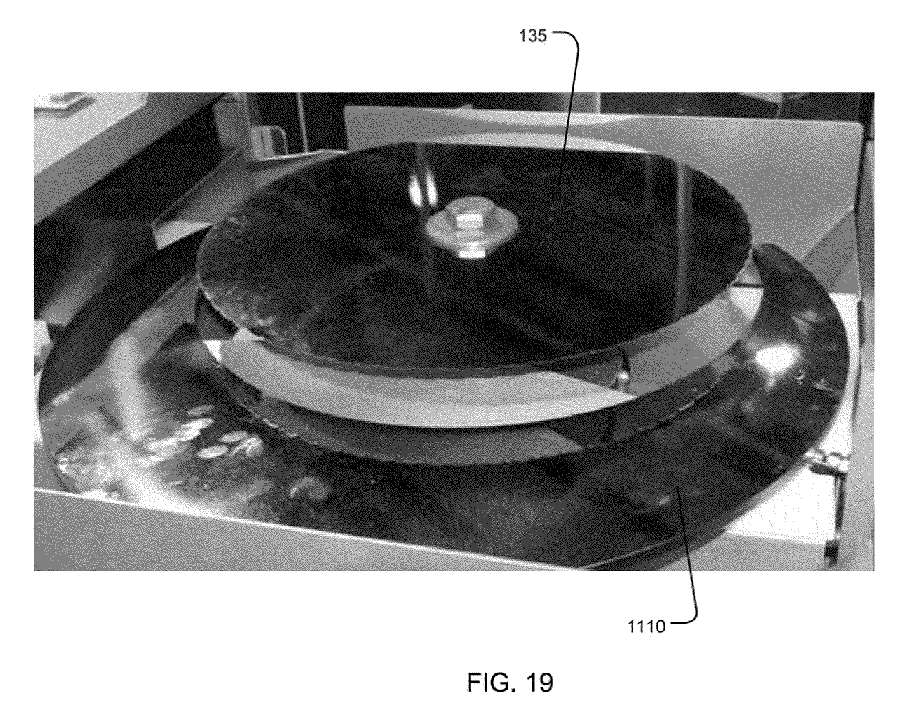

FIG. 19 shows an example of a cutting blade 135 and a thickness table 1110, according to principles of the disclosure.

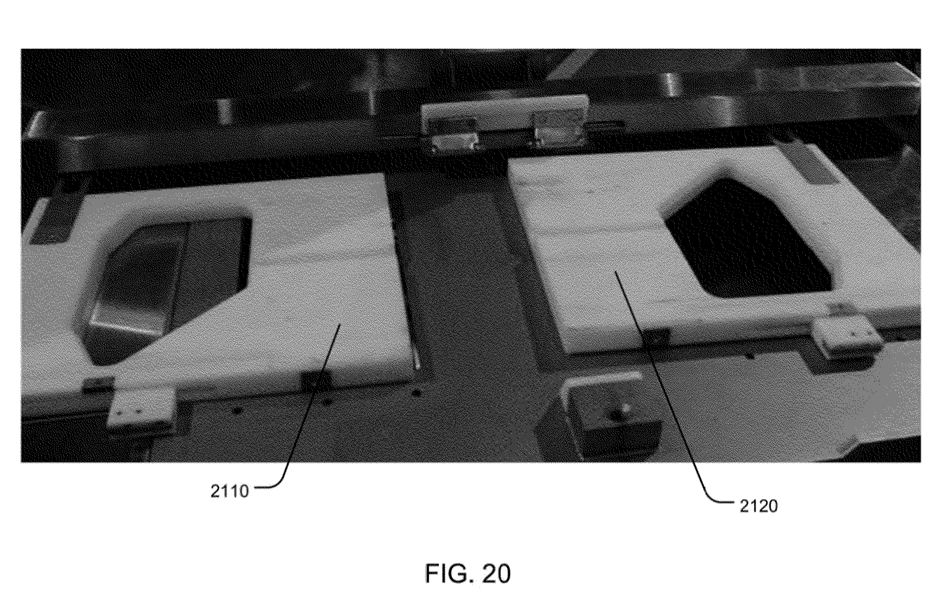

FIG. 20 shows an example of a pair of left and right shutters 2110, 2120, that may be used in the slicer 100 of FIG. 1, according to principles of the disclosure. As seen in FIG. 20, the shutters may be moved from, e.g., right to left, or left to right, to isolate the chutes 102, 104, from the slicing chamber, which includes the cutting area.

According to a further aspect of the disclosure, a computer readable medium is provided that contains a computer program, which when executed on a computer (e.g., controller 110, shown in FIG. 2), causes the computer to carry out each of the processes shown in FIGS. 6-16, and 18. In particular, the computer readable medium comprises a code section (or segment) for carrying out each step in the processes shown in FIGS. 6-16, and 18.

While the disclosure has been described in terms of exemplary embodiments, those skilled in the art will recognize that the disclosure can be practiced with modifications in the spirit and scope of the appended claim and drawings. The examples provided herein are merely illustrative and are not meant to be an exhaustive list of all possible designs, embodiments, applications or modifications of the disclosure. It is particularly significant to consider the resulting quality when the safe, isolated, bind-resistant chute (e.g., 102, 104, shown in FIG. 1) with the speed and pressure controlled product follower 1292, novel released coated cutting blade, low friction, anti-stick thickness table 1110 (that can be positioned for the SIM flush cycle), SIM or intermittent misting mode of operation and operated selected slicing mode are combined with a crusted injected bone-in meat product to provide high quality, smearless sliced meat or similar food products.

What is claimed:

1. A slicer system for cutting meat products from a primal, comprising:
an isolated chute that delivers the primal to a cutting area along a first direction;
a shuttle that moves a portion of the primal in a horizontal plane that is substantially perpendicular to the first direction;
a conveyor that supports and carries a meat product cut from the primal in the cutting area; and
a sprayer that applies a fluid to a cutting blade in the cutting area.

2. The slicer system according to claim 1, further comprising:
a chute drive that controls a position of the primal in the chute along the first direction;
a shuttle drive that controls the position of the primal in the horizontal plane;
a conveyor drive that moves the conveyor; and
a sprayer drive that regulates the supply of fluid to the cutting blade,
wherein the fluid comprises at least one of a lubricating fluid, a processing acid, water, or a preservative.

3. The slicer system according to claim 1, wherein the fluid is intermittently applied to the cutting blade.

4. The slicer system according to claim 1, wherein the cutting blade comprises a synergistic infused matrix coating.

5. The slicer system according to claim 4, wherein the synergistic infused matrix coating comprises at least one of:
an Endura® 203x3 coating;
an Armoloy XADC® coating;
an Endura® 202P coating;
a PenTuf®/En infused coating;
an EN/PenTuf® Infused coating;
a Nedox® coating;
a Plasmadize® coating;
a Goldenedge® coating;
a BryCoat™ Titanium Carbo-Nitride coating;
an Armoloy® TDC Thin Dense Chromium Finish coating;
a Wearalon® coating; or
a nickel alloy matrix with the controlled infusion of sub-micron sized particles of high temperature, low friction polymers.

6. The slicer system according to claim 5, wherein the synergistic infused matrix coating comprises:
a coating thickness of about 0.0001 inches to about 0.001 inches;
a maximum operating temperature of about 500° F. continuous;
a coefficient of thermal expansion of about 14 μm/m/° C.;
a modulus of elasticity of about 2.0×10⁵ N/mm²;
a hardness (Rockwell C) of about 62 to about 68;
a taber abrasion resistance of about 0.03 g;
a salt spray resistance of about 1500+h;
a friction coefficient, dynamic/static of at least 0.02 to about 0.08; or
a surface energy of about 14 to about 18 dyne-cm.

7. The slicer system according to claim 5, wherein the synergistic infused matrix coating is applied to the cutting blade by microcracking electroless nickel at high temperatures and infusing polytetrafluroethylene (PTFE) into the resultant cracks.

8. The slicer system according to claim 1, wherein the cutting blade comprises:
a sharpened edge;
a serrated edge;
a fine saw-tooth edge;
a smooth tapered radial ribbing edge; or
a slight beveling edge, including the Grantons.

9. The slicer system according to claim 1, further comprising:
a thickness table that regulates the thickness of the meat product,
wherein the cutting blade and thickness table comprises a smooth micro-finish with a non-stick release surface.

10. The slicer system according to claim 1, further comprising:
an eccentric cutter drive that drives the cutting blade.

11. A slicer for cutting meat products from a primal, comprising:
a chute that delivers the primal to a cutting area;
a blade that slices a meat product from the primal in the cutting area; and
a blade driver that is configured to drive the blade at varying speeds to regulate a slice rate,
wherein the slice rate is based on a temperature at which the primal is sliced, the quantity of a fat layer, or whether the primal comprises a bone.

12. The slicer according to claim 11, further comprising:
a conveyor that carries the meat product away from the cutting area.

13. The slicer according to claim 11, further comprising:
a shuttle that shuttles the meat product in the cutting area.

14. The slicer according to claim 11, further comprising:
a manifold that supplies a pressurized fluid to a nozzle,
wherein the nozzle applies a mist or a stream to the cutting blade in any one of three modes, including a continuous misting mode, an intermittent misting mode, or an isolated SIM flush cleaning mode.

15. A method for slicing a meat product from a primal, the method comprising:
displaying a main menu screen comprising a plurality of modes;
receiving a selected mode from the plurality of modes;
receiving a plurality of control parameters; and
adjusting at least one of a cutting blade speed, a cutter blade speed, a conveyor speed, a batch dwell speed and a cut pressure speed based on the received plurality of control parameters.

16. The method according to claim 15, wherein the plurality of modes comprise:
a machine setup mode;
a SIMS configure mode;
an intermittent misting configure mode;
a supervisory administration screen mode;
an options mode;
a manual movement mode;
an inputs screen mode;
an outputs screen mode;
a continuous thickness mode;
a continuous run mode;
a variable thickness mode;
a library screen mode;
a language mode; or
a security mode.

17. The method according to claim 15, wherein the plurality of control parameters comprise:
a meat product thickness;
a batch number; or
a number of slices.

18. The method according to claim 15, wherein the plurality of control parameters comprise:
a continuous misting control signal;
an intermittent misting control signal;
a SIMS control signal; or
a chute management control signal.

19. The method according to claim 15, further comprising:
cooling the primal to a deep crust chill or full temper prior to cutting.

20. The method according to claim 15, further comprising:
applying a fluid to a cutting blade on a basis of the plurality of control parameters.

21. The method according to claim 15, further comprising:
closing a shutter and isolating a primal in a chute;
moving a thickness table to a position for cleaning; and
applying a jet of fluid to the thickness table and a cutting blade to flush away any deposited fat smear.

22. The method according to claim 21, wherein the chute is isolated from a cutting area that includes the cutting blade and the thickness table.

23. The method according to claim 21, wherein the fluid comprises at least one of water, a processing acid, a flavor enhanced solution, a preservative, an antimicrobial solution, and an oil.

24. The method according to claim 23, wherein:
the processing acid comprises citric acid; or
the flavor enhanced solution comprises salt.

25. The method according to claim 21, further comprising:
sending effluent water containing the flushed away fat smear to a scupper;
screening fat from the effluent water; and
discarding the screened effluent water.

26. The slicer system according to claim 1, further comprising:
a linear transducer that is configured to provide an adjustable downward pressure on a product follower,
wherein the downward pressure is maintained at a constant value, regardless of the weight of the primal.

27. The slicer system according to claim 1, further comprising:
a removable handle that is configured to be placed in the chute,
wherein the removable handle facilitates easy and safe positioning of a product follower.
